(19) United States
(12) Patent Application Publication
(10) Pub. No.: US 2026/0149377 A1
(43) Pub. Date: May 28, 2026

(54) PROTECTION CIRCUIT FOR HIGH-POWER SWITCHING POWER SUPPLY AND MULTI-CHANNEL SWITCHING POWER SUPPLY

(71) Applicant: Joulwatt Technology Co., Ltd., Hangzhou City (CN)

(72) Inventors: Siyun WANG, Hangzhou (CN); Pitleong WONG, Hangzhou (CN); Rengang CHEN, Hangzhou (CN); Aimin XU, Hangzhou (CN)

(21) Appl. No.: 19/256,085

(22) Filed: Jun. 30, 2025

(30) Foreign Application Priority Data
Nov. 22, 2024 (CN) 202411686838.0

(51) Int. Cl. H02M 3/158; H02H 1/00; H02H 7/12; H02M 1/08; H02M 1/36

(52) U.S. Cl. CPC H02M 3/158; H02H 1/0007; H02H 7/1213; H02M 1/08; H02M 1/36

(57) ABSTRACT

The present disclosure relates to a protection circuit for a high-power switching power supply and a multi-channel switching power supply. By arranging a protection switch between an input capacitor and a switching circuit of the switching power supply, the protection switch is turned off when the switching power supply experiences an abnormality, thereby protecting the switching power supply. In the multi-channel switching power supply, a protection switch is arranged between an input capacitor and a switching circuit in each channel, and when an abnormality occurs in a specific channel, the protection switch corresponding to that channel is turned off to protect the circuit structure of that channel. According to the solution of the present disclosure, since the protection switch is arranged after the input capacitor, the stress requirements on the protection switch are significantly reduced, while also lowering the cost and footprint of the protection switch.

### CROSS-REFERENCE TO PRIOR APPLICATIONS

This application claims priority to Chinese Patent Application No. 202411686838.0, filed on Nov. 22, 2024, entitled “PROTECTION CIRCUIT FOR HIGH-POWER SWITCHING POWER SUPPLY AND MULTI-CHANNEL SWITCHING POWER SUPPLY,” the contents of which are incorporated herein by reference, including the full text of the specification, claims, drawings, and abstract.

### TECHNICAL FIELD

The present disclosure relates to the field of power electronics, and more particularly, to a protection circuit for a high-power switching power supply and a multi-channel switching power supply.

### BACKGROUND

With the rapid improvement in computing power of high-power chips, the output current capacity of switching power supplies that supply power to these high-power chips has also increased rapidly. Typically, multiple switching power supply circuits are required to power a high-power chip. As a result, the number of power switching transistors integrated on a single board has increased drastically, often reaching into the hundreds, which in turn causes a proportional increase in various issues on the board. When any one of the power switching transistors experiences a short circuit, the input voltage may be transmitted to the load side, leading to overvoltage damage to the load, and potentially causing the system board to fail.

As shown in FIG. 1, the conventional multi-channel switching power supply circuit introduces an electronic switch (such as switch S1) on the input side, which is arranged between an input terminal and an input capacitor of each switching power supply. When a short circuit occurs at the output, the electronic switch is turned off to cut off power from the input side, thereby preventing the system board from being damaged. However, this solution suffers from slow response, high switch stress, and the problem that a fault in any channel causes the entire power supply to shut down.

Therefore, there is a need to provide an improved technical solution to overcome the above-mentioned problems in the prior art.

### SUMMARY OF THE PRESENT DISCLOSURE

In view of the above, the present disclosure aims to provide a protection circuit for a high-power switching power supply and a multi-channel switching power supply to solve the problems of slow response and power-off of the entire circuit in the high-power switching power supplies in conventional technologies.

According to one embodiment of the present disclosure, a protection circuit for a high-power switching power supply is provided. The switching power supply comprises an input capacitor, a switching circuit, and a driver for controlling the switching circuit. The protection circuit comprises a protection switch. The protection switch is coupled between an input terminal and the switching circuit, and an external input voltage is processed by the input capacitor and then transmitted to the input terminal. The driver detects the operation state of the switching power supply, and when a fault in the switching power supply is detected, controls the protection switch to be turned off.

Optionally, the switching circuit comprises bridge-connected switching transistors and an inductor. When the protection switch is turned on, the switching circuit receives a signal from the input terminal and generates an output voltage after processing by the switching circuit.

Optionally, an upper switching transistor in the bridge-connected switching transistors is a high-voltage switching transistor, and a lower switching transistor is a low-voltage switching transistor. The voltage/current withstand capability of the protection switch is lower than that of the upper switching transistor.

Optionally, during a startup process of the switching power supply, the driver firstly controls the protection switch to be turned on, and then controls the switching circuit to enter the operation state. During a shutdown process of the switching power supply, the driver firstly controls the switching circuit to stop operation, and then controls the protection switch to be turned off.

Optionally, during normal operation, the driver detects a voltage across the protection switch. When the voltage across the protection switch exceeds a preset value, it is determined that the switching power supply has a fault.

Optionally, the protection switch, the switching circuit, and the driver are all integrated into a single chip, wherein the input terminal corresponds to an input pin of the chip.

In a second aspect, according to one embodiment of the present disclosure, a multi-channel switching power supply is provided. The multi-channel switching power supply comprises a plurality of switching circuits, each switching circuit receiving an input signal to generate a corresponding output signal, all of the output signals supplying power to a load. Each of the plurality of switching circuits comprises an input capacitor, a protection switch, a switching circuit, and a driver for controlling the switching circuit. The protection switch is coupled between an input terminal and the switching circuit, and an external input voltage is processed by the input capacitor and then transmitted to the input terminal. The driver detects an operation state of the switching power supply, and when a fault in the switching power supply is detected, controls the protection switch to be turned off.

Optionally, the switching circuit in each channel comprises bridge-connected switching transistors and an inductor. When the protection switch is turned on, the switching circuit receives a signal from the input terminal and generates a corresponding output voltage after processing by the switching circuit.

Optionally, an upper switching transistor in the bridge-connected switching transistors is a high-voltage switching transistor, and a lower switching transistor is a low-voltage switching transistor. The voltage/current withstand capability of the protection switch is consistent with that of the lower switching transistor.

Optionally, during a startup process of one channel of the switching power supply, the driver firstly controls the protection switch to be turned on, and then controls the switching circuit to enter the operation state. During a shutdown process of one channel of the switching power supply, the driver firstly controls the switching circuit to stop operation, and then controls the protection switch to be turned off.

Optionally, during normal operation, the driver in each channel detects a voltage across the protection switch. When the voltage across the protection switch in one channel exceeds a preset value, it is determined that a fault has occurred in that channel.

Optionally, when a fault occurs in one channel of the multi-channel switching power supply, the protection switch corresponding to that channel is turned off, while the other channels continue to operate normally.

Optionally, an input capacitor is coupled between a transmission terminal of the input signal and the input terminal, and the input capacitor is used to regulate the input signal transmitted to the input terminal.

Optionally, the protection switch, the switching circuit, and the driver of the multi-channel switching power supply are all integrated into a single chip, wherein the input terminal corresponds to an input pin of the chip.

Optionally, each channel of the multi-channel switching power supply further comprises a first capacitor, the first capacitor being coupled between the protection switch and the switching circuit, and a capacitance of the first capacitor is much smaller than that of the input capacitor.

By adopting the protection scheme of the high-power switching power supply in the present invention, a protection switch is arranged between the input capacitor and the switching circuit of the power supply. When an abnormal condition occurs in the switching power supply, the protection switch is turned off to safeguard the power supply. In the case of a multi-channel switching power supply, a protection switch is provided between the input capacitor and the switching circuit of each power stage. If an abnormality occurs in one channel, the protection switch for that channel is turned off to protect the circuit structure of that specific channel. With the scheme of this application, since the protection switch is arranged after the input capacitor, the stress requirements on the protection switch can be significantly reduced, thereby lowering the cost and footprint of the protection switch.

### BRIEF DESCRIPTION OF THE DRAWINGS

FIG. 1 is a circuit block diagram of a switching power supply according to the prior art;

FIG. 2 is a first circuit block diagram of a protection circuit for a high-power switching power supply according to the present disclosure;

FIG. 3 is a second circuit block diagram of a protection circuit for a high-power switching power supply according to the present disclosure;

FIG. 4 is a circuit block diagram of a multi-channel switching power supply according to the present disclosure.

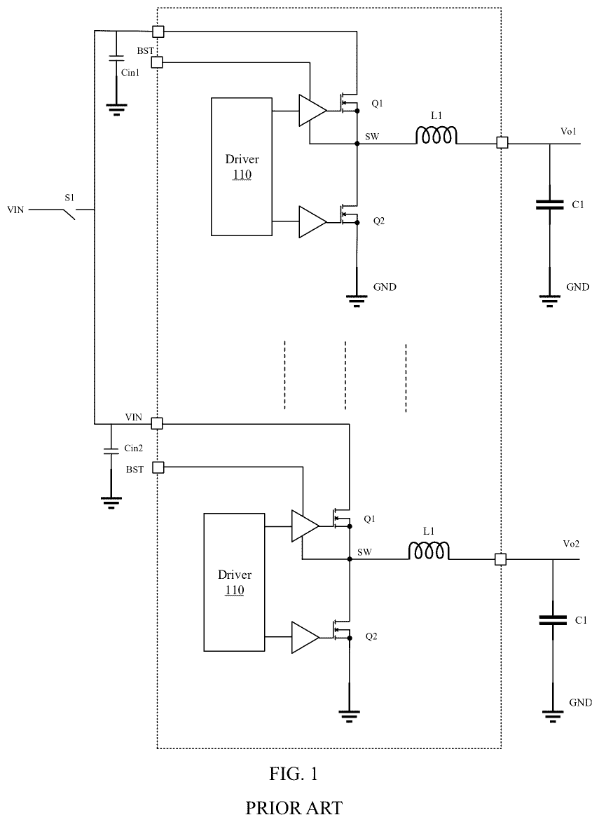

### DETAILED DESCRIPTION OF EMBODIMENTS

The following detailed description of preferred embodiments of the present disclosure is provided in conjunction with the accompanying drawings, but the present disclosure is not limited to these embodiments. the present disclosure encompasses any substitutions, modifications, equivalent methods, and solutions made within the spirit and scope of the present disclosure.

To ensure a thorough understanding of the present disclosure, specific details are provided in the following preferred embodiments. However, these details are not essential for a complete understanding of the present disclosure by those skilled in the art.

The present disclosure is described in more detail in the following paragraphs with reference to the drawings as examples. It should be noted that the drawings are simplified and use non-precise proportions, solely for the purpose of clearly and conveniently illustrating the objectives of the present disclosure.

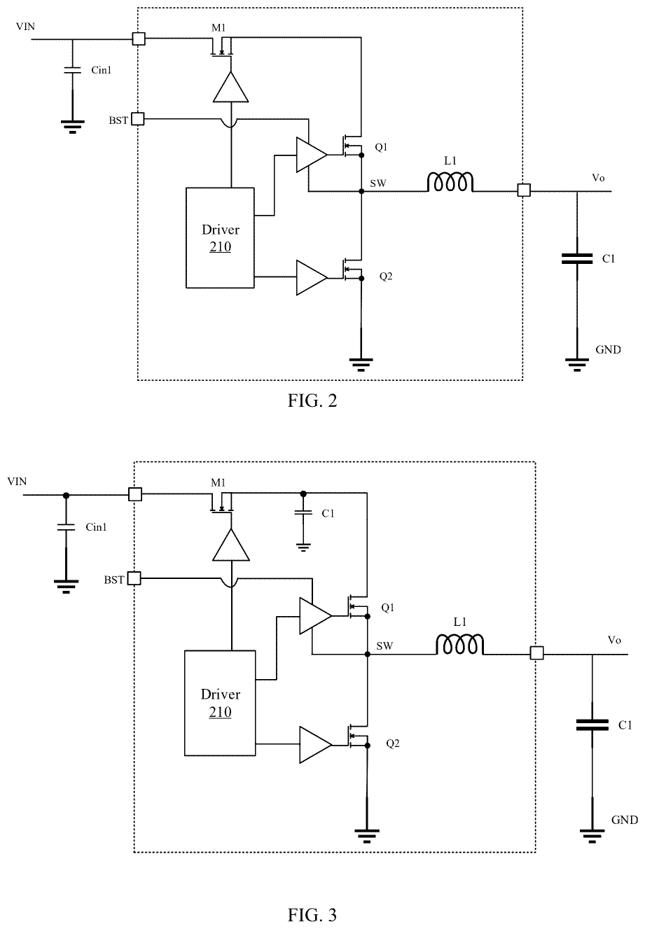

Referring to FIG. 2, a circuit block diagram of a protection circuit for a high-power switching power supply according to the present disclosure is shown. As shown in FIG. 2, the switching power supply comprises an input capacitor Cin, a switching circuit (the switching circuit comprises bridge-connected switching transistors Q1, Q2 and an inductor L1), and a driver 210 for controlling the switching circuit. The driver 210 is primarily used to drive the switching actions of the bridge-connected switching transistors. As shown in FIG. 2, the protection circuit comprises a protection switch M1. The protection switch may be a field-effect transistor or other suitable switching transistor. In this embodiment, a field-effect transistor is used as an example. The protection switch M1 is coupled between an input terminal and the switching circuit. When the protection switch M1 is turned on, the switching circuit receives a signal from the input terminal and generates an output voltage after processing by the switching circuit. In this embodiment, one end of the input capacitor is coupled to a node on the path from the input signal to the input terminal, and the other end is coupled to a reference ground. The external input voltage is processed by the input capacitor and then transmitted to the input terminal.

As shown in FIG. 2, the driver 210 detects an operation state of the switching power supply. When a fault in the switching power supply is detected, the driver 210 controls the protection switch M1 to be turned off. During normal operation, the driver 210 detects a voltage across the protection switch. When the voltage across the protection switch exceeds a preset value, it is determined that the switching power supply has a fault. In this embodiment, both the switching circuit and the protection circuit are driven and controlled by the driver. For example, the driver 210 detects a drain-source voltage difference across transistor M1. When the voltage difference exceeds the preset value, it indicates a short-circuit fault in the switching circuit. Here, the driver 210 controls the protection switch M1 to be turned off, thereby disconnecting the switching circuit from the input voltage and protecting the power switching transistors Q1 and Q2 or the load from damage.

Optionally, in the bridge-connected switching transistors Q1 and Q2, an upper switching transistor Q1 is a high-voltage switching transistor, and a lower switching transistor Q2 is a low-voltage switching transistor. The voltage/current withstand capability of the protection switch is lower than that of the upper switching transistor Q1. In high-power switching power supply applications, the output current is large, so main power switching transistors Q1 and Q2 (e.g., the upper switching transistor Q1) must withstand significant current and have high voltage/current requirements. In the present disclosure, by connecting the protection switch between the input terminal and the input of the switching circuit, the protection switch only needs to withstand the current from the parasitic capacitance of the upper and lower switching transistors Q1 and Q2. Its voltage requirement is minimal, potentially matching a withstand voltage of the lower switching transistor Q2. In contrast to prior art solutions where the protection switch is coupled before the input capacitor and requires high withstand voltages, the present disclosure reduces the voltage requirements of the protection switch, thereby decreasing its size and overall cost and footprint.

In the switching power supply shown in FIG. 2, during a startup process, the driver 210 firstly controls the protection switch to be turned on, and then controls the switching circuit to enter the operation state. During a shutdown process, the driver 210 firstly controls the switching circuit to stop operation, and then controls the protection switch to be turned off. This ensures the switching circuit operates normally while minimizing the switching stress on the protection switch M1 during startup and shutdown processes.

Optionally, in this embodiment, the protection switch, the switching circuit, and the driver 210 are all integrated into a single chip, with the input terminal corresponding to an input pin of the chip. The input capacitor Cin regulates and filters the input signal, and may consist of multiple capacitors, resulting in a relatively large capacitance value. It is typically arranged externally to the chip. In prior art solutions, the protection switch is coupled before the input capacitor, making integration impossible. In the present disclosure, by connecting the protection switch after the input capacitor and significantly reducing its withstand voltage, the protection switch can be integrated into the chip, achieving higher integration and improved smart control.

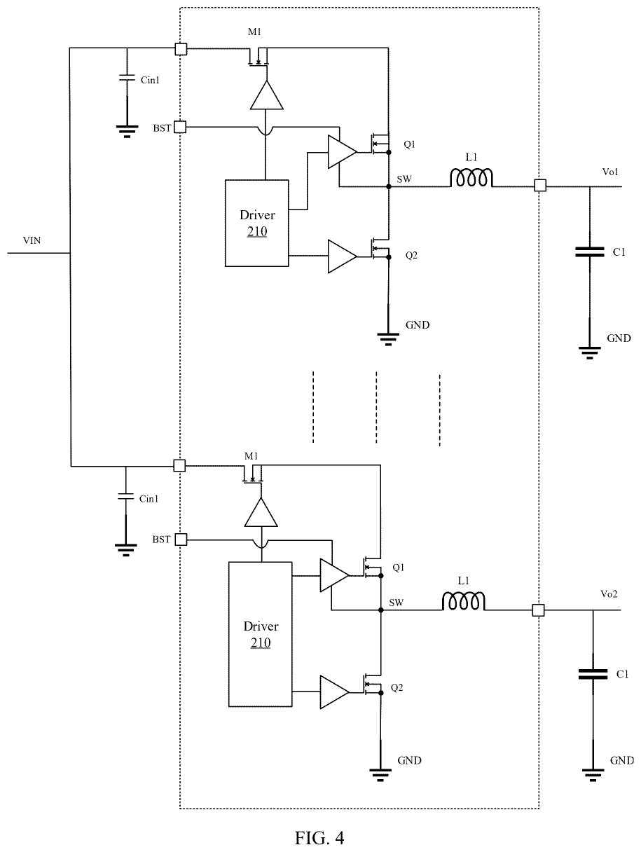

Referring to FIG. 3, a second circuit block diagram of a protection circuit for a high-power switching power supply according to the present disclosure is shown. This embodiment is similar to FIG. 2, except that a first capacitor is further coupled between the protection switch and the switching circuit. The capacitance of the first capacitor is much smaller than that of the input capacitor, for example, the first capacitor may have a capacitance of one-thousandth of the input capacitor (e.g., nanofarad level for the first capacitor and microfarad level for the input capacitor). This first capacitor can filter and decouple the signal input to the switching circuit. Due to its small capacitance and size, the first capacitor can be integrated within the chip.

Referring to FIG. 4, a circuit block diagram of a multi-channel switching power supply according to the present disclosure is shown. The multi-channel switching power supply comprises a plurality of switching circuits, each switching circuit receiving an input signal Vin (e.g., input voltage) to generate a corresponding output signal (e.g., output current and output voltage). In this embodiment, all of the output signals supply power to the load for high-current, high-power energy delivery. As shown in FIG. 4, each channel of the multi-channel switching circuits comprises an input capacitor Cin, a protection switch M1, a switching circuit, and a driver 210 for controlling the switching circuit. The driver 210 in each channel is used to drive the protection switch M1 and the switching transistors Q1 and Q2 in the switching circuit of the corresponding channel.

As shown in FIG. 4, the protection switch M1 is coupled between an input terminal and the switching circuit. The external input voltage is processed by the input capacitor Cin and then transmitted to the input terminal. The input capacitor Cin is coupled between a transmission terminal of the input signal and the input terminal, and is used to regulate the signal transmitted to the input terminal. The capacitance value of the input capacitor is relatively large.

The switching circuit in each channel comprises bridge-connected switching transistors Q1 and Q2, such as an upper switching transistor Q1 and a lower switching transistor Q2, and an inductor L1. When the protection switch is turned on, the switching circuit receives a signal from the input terminal and generates a corresponding output voltage after processing by the switching circuit. Optionally, an upper switching transistor Q1 in the bridge-connected switching transistors Q1 and Q2 is a high-voltage switching transistor, and a lower switching transistor Q2 is a low-voltage switching transistor. The voltage/current withstand capability of the protection switch is lower than that of the upper switching transistor Q1. In high-power switching power supply applications, the output current is large, so the main power switching transistors Q1 and Q2 (e.g., the upper switching transistor Q1) must withstand significant current and have high withstand voltage. In the present disclosure, by connecting the protection switch between the input terminal and the input of the switching circuit, the protection switch only needs to withstand the current from the parasitic capacitance of the upper and lower switching transistors Q1 and Q2. Its voltage requirement is minimal, potentially matching a withstand voltage of the lower switching transistor Q2. Compared to prior art solutions, the present disclosure significantly reduces the requirements for the protection switch, lowering the cost and footprint.

As shown in FIG. 4, the protection switch M1 is coupled between the input terminal and the switching circuit path. The driver 210 detects an operation state of the switching power supply. When a fault in the switching power supply is detected, the driver 210 controls the protection switch to be turned off. The protection switch M1 may be a field-effect transistor or other suitable switching transistor. In this embodiment, a field-effect transistor is used as an example, and the upper and lower switching transistors Q1 and Q2 in the switching circuit are also field-effect transistors. During normal operation of the switching power supply, the driver 210 detects a voltage across the protection switch. When the voltage across the protection switch exceeds a preset value, it is determined that the switching power supply has a fault. The preset value may be an overvoltage threshold. For example, the driver 210 detects a drain-source voltage difference across transistor M1. When the voltage difference exceeds the preset value, it indicates a short-circuit fault in the switching circuit. Here, the driver 210 controls the protection switch M1 to be turned off, thereby disconnecting the switching circuit from the input voltage and protecting the power switching transistors Q1 and Q2 or the load from damage.

Optionally, during a startup process of one channel of the multi-channel switching power supply, the driver firstly controls the protection switch to be turned on, and then controls the switching circuit to enter the operation state. During a shutdown process of one channel of the switching power supply, the driver firstly controls the switching circuit to stop operation, and then controls the protection switch to be turned off. In a multi-channel switching power supply, depending on the power consumption of the load, it may be necessary to activate or deactivate a specific channel. By using the aforementioned method, each channel of the switching circuit can be safely turned on and off in sequence, and the requirements for the protection switch are reduced.

In the solution of the present invention, when a fault occurs in one channel of the multi-channel switching power supply, the protection switch corresponding to that channel is turned off, while the other channels continue to operate normally. This allows for the quick disconnection of the faulty channel from the system bus voltage when a fault occurs in that channel, while the operation states of the other channels remain unaffected, maintaining the output voltage and preventing damage to the load.

Optionally, in this embodiment, the protection switch, the switching circuit, and the driver of the multi-channel switching power supply are all integrated into a single chip, wherein the input terminal corresponds to an input pin of the chip. In prior art solutions, the input capacitor cannot be integrated due to its large capacitance, and therefore the protection switch coupled before the input capacitor cannot be integrated either. The present disclosure allows the protection switch to be integrated, improving system integration and smart control. The multi-channel switching power supply of the present disclosure may include multiple sub-switching circuit units, each of which may include multiple channels. Therefore, even when the number of switching transistors reaches over one hundred, the operation in each channel is unaffected by others, and high integration is achievable.

Similarly, for the multi-channel switching power supply, each channel may further include a first capacitor. The first capacitor is coupled between the protection switch and the switching circuit, and its capacitance is much smaller than that of the input capacitor, for example, one-thousandth of the input capacitor's capacitance. This first capacitor can filter and decouple the signal input to the switching circuit. Due to its small capacitance and size, the first capacitor can be integrated within the chip.

It should be noted that the specific embodiments and corresponding figures provided are merely illustrative of one method of implementing the present disclosure and are not intended to limit the specific structure of the present disclosure. Any modifications or changes made without departing from the principles and essence of the present disclosure are within the scope of the present disclosure.

Although the embodiments have been described and explained separately above, common technical aspects may be shared among them. For a person skilled in the art, these shared aspects may be interchangeable or combined between embodiments. For any content not explicitly described in one embodiment, reference may be made to another embodiment where such content is described.

The above-described embodiments are not intended to limit the scope of the technical solution. Any modifications, equivalent substitutions, or improvements made within the spirit and principles of the present disclosure should be included in the scope of the technical solution.

What is claimed is:

1. A protection circuit for a high-power switching power supply, the switching power supply comprising an input capacitor, a switching circuit, and a driver for controlling the switching circuit, wherein the protection circuit comprises a protection switch,
the protection switch is coupled between an input terminal and the switching circuit, and an external input voltage is processed by the input capacitor and then transmitted to the input terminal,
the driver detects an operation state of the switching power supply, and when a fault in the switching power supply is detected, it controls the protection switch to be turned off.

2. The protection circuit for the high-power switching power supply according to claim 1, wherein the switching circuit comprises bridge-connected switching transistors and an inductor,
when the protection switch is turned on, the switching circuit receives a signal from the input terminal and generates an output voltage after being processed by the switching circuit.

3. The protection circuit for the high-power switching power supply according to claim 2, wherein an upper switching transistor in the bridge-connected switching transistors is a high-voltage switching transistor, and a lower switching transistor is a low-voltage switching transistor,
the voltage/current withstand capability of the protection switch is lower than that of the upper switching transistor.

4. The protection circuit for the high-power switching power supply according to claim 1, characterized in that,
during a startup process of the switching power supply, the driver firstly controls the protection switch to be turned on, and then controls the switching circuit to enter the operation state;
during a shutdown process of the switching power supply, the driver firstly controls the switching circuit to stop operation, and then controls the protection switch to be turned off.

5. The protection circuit for the high-power switching power supply according to claim 1, wherein during normal operation, the driver detects a voltage across the protection switch, and when the voltage across the protection switch exceeds a preset value, it determines that the switching power supply has a fault, and the driver controls the protection switch to be turned off.

6. The protection circuit for the high-power switching power supply according to claim 1, wherein the protection switch, the switching circuit, and the driver are all integrated into a single chip, wherein the input terminal corresponds to an input pin of the chip.

7. The protection circuit for the high-power switching power supply according to claim 6, wherein a first capacitor is further coupled between the protection switch and the switching circuit,
a capacitance of the first capacitor is much smaller than that of the input capacitor.

8. A multi-channel switching power supply, comprising a plurality of switching circuits, each switching circuit receiving an input signal to generate a corresponding output signal, all of the output signals supplying power to a load, wherein each of the plurality of switching circuits comprises an input capacitor, a protection switch, a switching circuit, and a driver for controlling the switching circuit,
the protection switch is coupled between an input terminal and the switching circuit, and an external input voltage is processed by the input capacitor and then transmitted to the input terminal,
the driver detects an operation state of the switching power supply, and when a fault in the switching power supply is detected, it controls the protection switch to be turned off.

9. The multi-channel switching power supply according to claim 8, wherein the switching circuit in each channel comprises bridge-connected switching transistors and an inductor, when the protection switch is turned on, the switching circuit receives a signal from the input terminal and generates a corresponding output voltage after being processed by the switching circuit.

10. The multi-channel switching power supply according to claim 9, wherein an upper switching transistor in the bridge-connected switching transistors is a high-voltage switching transistor, and a lower switching transistor is a low-voltage switching transistor, the voltage/current withstand capability of the protection switch is lower than that of the upper switching transistor.

11. The multi-channel switching power supply according to claim 8, characterized in that, during a startup process of one channel of the switching power supply, the driver firstly controls the protection switch to be turned on, and then controls the switching circuit to enter the operation state;
during a shutdown process of one channel of the switching power supply, the driver firstly controls the switching circuit to stop operation, and then controls the protection switch to be turned off.

12. The multi-channel switching power supply according to claim 8, wherein during normal operation, the driver in each channel detects a voltage across the protection switch, and when the voltage across the protection switch in one channel exceeds a preset value, it is determined that a fault has occurred in that channel.

13. The multi-channel switching power supply according to claim 12, wherein when a fault occurs in one channel of the multi-channel switching power supply, the protection switch corresponding to that channel is turned off, while the other channels continue to operate normally.

14. The multi-channel switching power supply according to claim 8, wherein the input capacitor is coupled between a transmission terminal of the input signal and the input terminal, and the input capacitor is used to regulate an input voltage transmitted to the input terminal.

15. The multi-channel switching power supply according to claim 8, wherein the protection switch, the switching circuit, and the driver of the multi-channel switching power supply are all integrated into a single chip, wherein the input terminal corresponds to an input pin of the chip.

16. The multi-channel switching power supply according to claim 15, wherein each channel of the multi-channel switching power supply further comprises a first capacitor, the first capacitor being coupled between the protection switch and the switching circuit, and a capacitance of the first capacitor is much smaller than that of the input capacitor.
